(19) United States
(12) Patent Application Publication
(10) Pub. No.: US 2024/0156084 A1
(43) Pub. Date: May 16, 2024

(54) ANTI-AGGLOMERATION SUSTAINED-RELEASE INORGANIC ANTIBACTERIAL MATERIAL AND PREPARATION METHOD THEREOF

(71) Applicant: SHANGHAI RUNHE NANO MATERIAL SCI.&TECH. CO., LTD, Shanghai (CN)

(72) Inventors: Zhiqing TAO, Shanghai (CN); Lili CUI, Shanghai (CN)

(21) Appl. No.: 17/782,179

(22) PCT Filed: Jan. 26, 2022
(86) PCT No.: PCT/CN2022/073985

§ 371 Date: Jun. 3, 2022

(30) Foreign Application Priority Data
Feb. 7, 2021 (CN) 202110179254.4

(51) Int. Cl. A01N 25/08; A01N 59/16

(52) U.S. Cl. CPC A01N 25/08; A01N 59/16

(57) ABSTRACT

The present invention discloses an anti-agglomeration sustained-release inorganic antibacterial material. A carrier of the sustained-release inorganic antibacterial material is a titanate coupling agent and nano-zinc oxide modified phosphate. The sustained-release inorganic antibacterial material further contains an element Ag. The prepared anti-agglomeration sustained-release inorganic antibacterial material has an excellent antibacterial ability.

### TECHNICAL FIELD

The present invention belongs to the technical field of antibacterial materials, and in particular, relates to an anti-agglomeration sustained-release inorganic antibacterial material and a preparation process thereof.

### BACKGROUND

Antibacterial agents can be roughly divided into three categories according to their components: natural antibacterial agents, organic antibacterial agents and inorganic antibacterial agents. The natural antibacterial agents are mainly extracts from natural plants. Due to the limitation of resources, it is difficult to apply and promote them. The organic antibacterial agents have been applied for many years. As traditional antibacterial agents, the organic antibacterial agents have been widely applied in medical and industrial fields. Although they have strong bactericidal power, they have defects in terms of use safety, durability, broad-spectrum antibacterial property, high temperature resistance, etc. Compared with the organic antibacterial agents, the inorganic antibacterial agents have obvious advantages in terms of safety, durability, heat resistance, etc. Silver-based antibacterial agents in the inorganic antibacterial agents have the incomparable antibacterial ability to other metals, and have a strong antibacterial effect on bacteria, fungi and moulds. Their antibacterial effect has the characteristics such as broad-spectrum long acting, safety and no side effects, and they consume very little, have good durability, and are difficult to aggregate in the human body. They are chemically called permanent bactericides. There are two main types of silver-based inorganic antibacterial materials, one is pure nano-silver antibacterial materials, and the other is silver-loaded inorganic antibacterial materials with metallic silver ions as antibacterial components and various inorganic minerals as carriers.

The silver-loaded inorganic antibacterial materials mainly precipitate silver ions onto the surfaces of inorganic materials or into mesoporous materials through the actions such as ion exchange and physical adsorption, for preparing the inorganic antibacterial agents for being made to have an antibacterial effect. The silver-loaded inorganic antibacterial materials combine with cell membranes and membrane proteins through slowly released silver ions to cause the damage to main structures of cells and form a dysfunction in a short period of time. The silver ions reaching the interiors of the cells cause an enzymatic disorder in an electron conduction system or react with DNA to form a dysfunction. However, the surface free energy of inorganic antibacterial agent powder is high, and the antibacterial agents are easy to agglomerate together in body materials, which will have a negative impact on the mechanical properties of the materials and the sustained release of the antibacterial agents.

### SUMMARY

In order to solve the above problems, the present invention provides an anti-agglomeration sustained-release inorganic antibacterial material, wherein a carrier of the sustained-release inorganic antibacterial material is a modified phosphate, and the sustained-release inorganic antibacterial material further contains an element Ag.

As a preferred technical solution, the modified phosphate is at least one of modified zirconium phosphate and modified calcium phosphate.

As a preferred technical solution, the modified phosphate is prepared by the following modification method:

putting the phosphate and nano-zinc oxide in water, conducting ultrasonic dispersion and stirring until evenness, adding an ethanol solution of a titanate coupling agent for even mixing and then conducting stirring in a thermostatic water bath, conducting still standing for layering, and taking lower-layer powder for drying for obtaining the modified phosphate.

As a preferred technical solution, an average particle size of the nano-zinc oxide is 10-30 nm.

As a preferred technical solution, a specific surface area of the nano-zinc oxide is greater than 70 m²/g.

As a preferred technical solution, a weight ratio of the phosphate to the nano-zinc oxide is (8-15):1.

As a preferred technical solution, a weight ratio of the nano-zinc oxide to the titanate coupling agent is (2-4):1.

The present invention further provides a preparation method of an anti-agglomeration sustained-release inorganic antibacterial material, including the following steps:
S1, adding the modified phosphate into a silver nitrate solution for stirring;
S2, adjusting a PH of the solution to 10-12, and conducting aging;
S3, rinsing a precipitate with water until a filtrate is neutral, and drying the precipitate; and
S4, adding polyethylene glycol into the dried precipitate for even mixing, and conducting sintering to obtain powder, namely the anti-agglomeration sustained-release inorganic antibacterial material.

As a preferred technical solution, a sintering temperature is 1000° C.-1200° C.

As a preferred technical solution, a number-average molecular weight of the polyethylene glycol is 5000-8000.

Beneficial effects are as follows.

In the present invention, through a titanate coupling agent and nano-zinc oxide modified phosphate, the surface free energy of an inorganic antibacterial material is improved, the problem that the antibacterial agent is easy to agglomerate in a body material is solved, and meanwhile, the sustained release effect of antibacterial ions is improved. The prepared antibacterial material can release silver ions and zinc ions to destroy a bacterial structure, improving the antibacterial applicability of the anti-agglomeration sustained-release inorganic antibacterial material in different environments.

### DETAILED DESCRIPTION OF EMBODIMENTS

The content of the present invention can be further understood in conjunction with the following detailed description of the preferred implementation methods of the present invention and the included examples. Unless otherwise specified, all technical and scientific terms used herein have the same meanings as commonly understood by those of ordinary skill in the field to which the present invention belongs. In the event that the definitions of specific terms disclosed in the prior art are inconsistent with any definitions provided in the present invention, the definitions of the terms provided in the present invention shall prevail.

As used herein, features not limited to the singular and plural are also intended to include features in the plural unless clearly indicated otherwise in the context. It should also to be understood that for example, the term “prepared from . . . ” as used herein is synonymous with “containing”, and “comprising”, “including”, “having”, “containing” and/or “consisting of”, when used in this specification, means the recited composition, step, method, article, or apparatus, but the presence or addition of one or more of other compositions, steps, methods, articles or apparatuses is not precluded. In addition, when the embodiments of the present invention are described, the use of “preferred”, “preferably”, “more preferred”, etc., refers to implementation solutions of the present invention that may provide certain beneficial effects under certain circumstances. However, other implementation solutions may also be preferred under the same or other circumstances. Besides, the recitation of one or more preferred implementation solutions does not imply that other implementation solutions are not available, nor is it intended to exclude other implementation solutions from the scope of the present invention.

In order to solve the above problems, the first aspect of the present invention provides an anti-agglomeration sustained-release inorganic antibacterial material, wherein a carrier of the sustained-release inorganic antibacterial material is a modified phosphate, and the sustained-release inorganic antibacterial material further contains an element Ag.

The phosphate has the outstanding advantages of high temperature resistance, no discoloration, safety and stability and is an excellent choice as a carrier for an antibacterial material. However, due to the high surface free energy, phosphate powder has a strong agglomeration tendency, while a body material has low surface free energy and is lipophilic, so the compatibility between the two is poor. An antibacterial agent is easy to agglomerate together in the body material, which will have a negative impact on the mechanical properties of the materials and the sustained release of the antibacterial agent. In order to solve this problem, the present invention conducts modification treatment on the phosphate. In some preferred embodiments, the modified phosphate is at least one of modified zirconium phosphate and modified calcium phosphate.

In some preferred embodiments, the modified phosphate is prepared by the following modification method:
the phosphate and nano-zinc oxide are put in water, ultrasonic dispersion and stirring are conducted until evenness, an ethanol solution of a titanate coupling agent is added, stirring is conducted for 1 to 1.5 hours in a 50° C. to 60° C. thermostatic water bath under 800 to 1000 r/min, then still standing for layering is conducted, and lower-layer powder is taken for drying for obtaining the modified phosphate.

In some preferred embodiments, an average particle size of the nano-zinc oxide is 10 to 30 nm. The nano-zinc oxide with the average particle size of 10 to 30 nm is conducive to formation of chemical grafting on a surface of the phosphate under the action of the titanate coupling agent, and reduces the surface energy of the phosphate together with the titanate coupling agent, which prevents agglomeration among particles, and is conducive to uniform dispersion. In addition, the grafted nano-zinc oxide releases zinc ions under the action of water molecules in the air under a dark environment. Due to the oxidation and deoxidization properties of the zinc ions, a protein structure of a bacterial cell membrane can be destroyed to achieve a bactericidal effect. In some preferred embodiments, a specific surface area of the nano-zinc oxide is greater than 70 m²/g, which is beneficial to release more zinc ions to contact with bacteria, thereby improving the bactericidal effect. In some preferred embodiments, a weight ratio of the phosphate to the nano-zinc oxide is (8 to 15):1. In some preferred embodiments, a weight ratio of the nano-zinc oxide to the titanate coupling agent is (2 to 4):1.

In some preferred embodiments, the titanate coupling agent includes at least one of isopropyl triisostearoyl titanate, isopropyl tris(dioctyl pyrophosphoryl)titanate, bis(dioctyl pyrophosphoryl)ethylene titanate, isopropyl bis(methacryloyl)isostearoyl titanate, isopropyl tris(dioctyl phosphoryl)titanate, isopropyl tris(dodecyl benzenesulfonyl)titanate, and isopropyl tris(n-ethylamino-ethylamino)titanate. Through the modification treatment of the titanate coupling agent, the sustained-release effect of the subsequently prepared anti-agglomeration sustained-release inorganic antibacterial material is also improved.

The present invention further provides a preparation method of an anti-agglomeration sustained-release inorganic antibacterial material, including the following steps:
S1, the modified phosphate is added into a silver nitrate solution for stirring;
S2, a PH of the solution is adjusted to 10 to 12, and aging is conducted for 8 to 12 hours, which are beneficial to improve an exchange rate of silver ions;
S3, a precipitate is rinsed with water until a filtrate is neutral, and the precipitate is dried; and
S4, polyethylene glycol is added into the dried precipitate for even mixing, and sintering is conducted to obtain powder, namely the anti-agglomeration sustained-release inorganic antibacterial material.

The prepared anti-agglomeration sustained-release inorganic antibacterial material has an excellent antibacterial property. During use, on the one hand, the anti-agglomeration sustained-release inorganic antibacterial material can also release a certain amount of silver ions and zinc ions, which can penetrate bacterial cell walls to replace the positions of cations on cell membrane surfaces to be combined with proteins or other anionic groups, making an original biological function of cells lose to achieve an antibacterial purpose. On the other hand, partial oxidized silver and oxidized zinc in the anti-agglomeration sustained-release inorganic antibacterial material activate oxygen in the air or water under the action of light to generate hydroxyl radicals and superoxide radicals with strong oxidation and deoxidization effects so as to destroy the proliferation ability of the bacterial cells to generate an antibacterial property.

As a preferred technical solution, a sintering temperature is 1000° C. to 1200° C.

As a preferred technical solution, a number-average molecular weight of the polyethylene glycol is 5000 to 8000. The addition of high molecular weight polyethylene glycol not only improves the dispersion performance of the powder, but also improves its antibacterial performance, and successfully solves the problem of discoloration.

A final product of the present invention is ultrafine powder, which can be very easily added to fibers, plastics, coatings, ceramics and paper to prepare various antibacterial products. It can also be used for preparation of a slurry or mixed and copolymerized with a monomer.

The present invention will be specifically described below by means of examples. It is necessary to point out that the following examples are only used to further illustrate the present invention, and should not be construed as limiting the scope of protection of the present invention, and some non-essential improvements and adjustments made by those specialized and skilled in the art according to the above content of the present invention still belong to the protection scope of the present invention.

In addition, all raw materials used are commercially available unless otherwise stated.

### EXAMPLES

The technical solutions of the present invention will be described in detail below through examples, but the protection scope of the present invention is not limited to the examples.

### Example 1

Example 1 provided an anti-agglomeration sustained-release inorganic antibacterial material, wherein a carrier of the sustained-release inorganic antibacterial material was a modified zirconium phosphate, and the sustained-release inorganic antibacterial material further contained an element Ag.

The modified zirconium phosphate was prepared by the following modification method:
30 g of zirconium phosphate powder and 3 g of nano-zinc oxide were put in 200 ml of water. Ultrasonic dispersion and stirring were conducted to obtain a uniform solution. 1 g of an isopropyl tris(dioctyl phosphoryl)titanate coupling agent was added into 30 ml of an ethanol solution to be mixed evenly, and then the above solution was added. Stirring was conducted for 1 hour in a 55° C. thermostatic water bath under 800 r/min, then still standing for layering was conducted. Lower-layer powder was taken for drying to obtain the modified zirconium phosphate.

The zirconium phosphate powder was purchased from Shanghai Runhe Nano Material Sci. & Tech. Co., Ltd., and a designation thereof was RHA-ZR. The nano-zinc oxide had an average particle size of 20 nm, and was purchased from Hefei ZhongHang Nanometer Technology Development Co., Ltd., and a model thereof was ZH-ZnO20N. The isopropyl tris(dioctyl phosphoryl)titanate coupling agent was purchased from American Kenrich Company, and a designation thereof was KR-12.

The present invention further provided a preparation method of an anti-agglomeration sustained-release inorganic antibacterial material, including the following steps:
S1, 5 g of modified zirconium phosphate was taken to be added into 300 ml of a 0.005 mol/L silver nitrate solution for stirring for 3 hours;
S2, a PH of the solution was adjusted to 11, and aging was conducted for 8 hours;
S3, a precipitate was rinsed with water until a filtrate was neutral, and the precipitate was dried; and
S4, polyethylene glycol of the same weight parts as the dried precipitation was added into the dried precipitate for even mixing, and sintering was conducted at 1100° C. to obtain powder, namely the sustained-release inorganic antibacterial material.

The polyethylene glycol had a number-average molecular weight of 5500 to 7000, and was purchased from Haian Petrochemical Plant in Jiangsu Province, and a model thereof was PEG-6000.

### Example 2

Example 2 provided an anti-agglomeration sustained-release inorganic antibacterial material, wherein a carrier of the sustained-release inorganic antibacterial material was a modified zirconium phosphate, and the sustained-release inorganic antibacterial material further contained an element Ag.

The modified zirconium phosphate was prepared by the following modification method:
30 g of zirconium phosphate powder and 2 g of nano-zinc oxide were put in 200 ml of water. Ultrasonic dispersion and stirring were conducted to obtain a uniform solution. 1 g of an isopropyl tris(dioctyl phosphoryl)titanate coupling agent was added into 30 ml of an ethanol solution to be mixed evenly, and then the above solution was added. Stirring was conducted for 1 hour in a 55° C. thermostatic water bath under 800 r/min, then still standing for layering was conducted. Lower-layer powder was taken for drying to obtain the modified zirconium phosphate.

The zirconium phosphate powder was purchased from Shanghai Runhe Nano Material Sci. & Tech. Co., Ltd., and a designation thereof was RHA-ZR. The nano-zinc oxide had an average particle size of 20 nm, and was purchased from Hefei ZhongHang Nanometer Technology Development Co., Ltd., and a model thereof was ZH-ZnO20N. The isopropyl tris(dioctyl phosphoryl)titanate coupling agent was purchased from American Kenrich Company, and a designation thereof was KR-12.

The present invention further provided a preparation method of an anti-agglomeration sustained-release inorganic antibacterial material, including the following steps:
S1, 5 g of modified zirconium phosphate was taken to be added into 300 ml of a 0.004 mol/L silver nitrate solution for stirring for 3 hours;
S2, a PH of the solution was adjusted to 12, and aging was conducted for 10 hours;
S3, a precipitate was rinsed with water until a filtrate was neutral, and the precipitate was dried; and
S4, polyethylene glycol of the same weight parts as the dried precipitation was added into the dried precipitate for even mixing, and sintering was conducted at 1050° C. to obtain powder, namely the sustained-release inorganic antibacterial material.

The polyethylene glycol had a number-average molecular weight of 5500 to 7000, and was purchased from Haian Petrochemical Plant in Jiangsu Province, and a model thereof was PEG-6000.

### Example 3

Example 3 provided an anti-agglomeration sustained-release inorganic antibacterial material, wherein a carrier of the sustained-release inorganic antibacterial material was a modified calcium phosphate, and the sustained-release inorganic antibacterial material further contained an element Ag.

The modified calcium phosphate was prepared by the following modification method:
30 g of calcium phosphate powder and 3 g of nano-zinc oxide were put in 200 ml of water. Ultrasonic dispersion and stirring were conducted to obtain a uniform solution. 1 g of an isopropyl tris(dioctyl phosphoryl)titanate coupling agent was added into 30 ml of an ethanol solution to be mixed evenly, and then the above solution was added. Stirring was conducted for 1 hour in a 55° C. thermostatic water bath under 800 r/min, and then still standing for layering was conducted. Lower-layer powder was taken for drying to obtain the modified calcium phosphate.

The calcium phosphate powder was purchased from Shanghai Runhe Nano Material Sci. & Tech. Co., Ltd. The nano-zinc oxide had an average particle size of 20 nm, and was purchased from Hefei ZhongHang Nanometer Technology Development Co., Ltd., and a model thereof was ZH-ZnO20N. The isopropyl tris(dioctyl phosphoryl)titanate coupling agent was purchased from American Kenrich Company, and a designation thereof was KR-12.

The present invention further provided a preparation method of an anti-agglomeration sustained-release inorganic antibacterial material, including the following steps:
S1, 5 g of modified calcium phosphate was taken to be added into 300 ml of a 0.005 mol/L silver nitrate solution for stirring for 3 hours;
S2, a PH of the solution was adjusted to 11, and aging was conducted for 8 hours;
S3, a precipitate was rinsed with water until a filtrate was neutral, and the precipitate was dried; and
S4, polyethylene glycol of the same weight parts as the dried precipitation was added into the dried precipitate for even mixing, and sintering was conducted at 1100° C. to obtain powder, namely the sustained-release inorganic antibacterial material.

The polyethylene glycol had a number-average molecular weight of 5500 to 7000, and was purchased from Haian Petrochemical Plant in Jiangsu Province, and a model thereof was PEG-6000.

### Comparative Example 1

Comparative Example 1 provided an anti-agglomeration sustained-release inorganic antibacterial material, wherein a carrier of the sustained-release inorganic antibacterial material was a modified zirconium phosphate, and the sustained-release inorganic antibacterial material further contained an element Ag.

The modified zirconium phosphate was prepared by the following modification method:
30 g of zirconium phosphate powder was put in 200 ml of water. Ultrasonic dispersion and stirring were conducted to obtain a uniform solution. 1 g of an isopropyl tris(dioctyl phosphoryl)titanate coupling agent was added into 30 ml of an ethanol solution to be mixed evenly, and then the above solution was added. Stirring was conducted for 1 hour in a 55° C. thermostatic water bath under 800 r/min, and then still standing for layering was conducted. Lower-layer powder was taken for drying to obtain the modified phosphate.

The zirconium phosphate powder was purchased from Shanghai Runhe Nano Material Sci. & Tech. Co., Ltd., and a designation thereof was RHA-ZR. The isopropyl tris(dioctyl phosphoryl)titanate coupling agent was purchased from American Kenrich Company, and a designation thereof was KR-12.

The present invention further provided a preparation method of an anti-agglomeration sustained-release inorganic antibacterial material, including the following steps:
S1, 5 g of a modified phosphate was taken to be added into 300 ml of a 0.005 mol/L silver nitrate solution for stirring for 3 hours;
S2, a PH of the solution was adjusted to 11, and aging was conducted for 8 hours;
S3, a precipitate was rinsed with water until a filtrate was neutral, and the precipitate was dried; and
S4, polyethylene glycol of the same weight parts as the dried precipitation was added into the dried precipitate for even mixing, and sintering was conducted at 1100° C. to obtain powder, namely the sustained-release inorganic antibacterial material.

The polyethylene glycol had a number-average molecular weight of 5500 to 7000, and was purchased from Haian Petrochemical Plant in Jiangsu Province, and a model thereof was PEG-6000.

### Comparative Example 2

Comparative Example 2 provided an anti-agglomeration sustained-release inorganic antibacterial material, wherein a carrier of the sustained-release inorganic antibacterial material was a modified zirconium phosphate, and the sustained-release inorganic antibacterial material further contained an element Ag.

The modified zirconium phosphate was prepared by the following modification method:
30 g of zirconium phosphate powder and 3 g of nano-zinc oxide were put in 200 ml of water. Ultrasonic dispersion and stirring were conducted to obtain a uniform solution. 0.5 g of an isopropyl tris(dioctyl phosphoryl)titanate coupling agent was added into 30 ml of an ethanol solution to be mixed evenly, and then the above solution was added. Stirring was conducted for 1 hour in a 55° C. thermostatic water bath under 800 r/min, and then still standing for layering was conducted. Lower-layer powder was taken for drying to obtain the modified calcium phosphate.

The zirconium phosphate powder was purchased from Shanghai Runhe Nano Material Sci. & Tech. Co., Ltd., and a designation thereof was RHA-ZR. The nano-zinc oxide had an average particle size of 20 nm, and was purchased from Hefei ZhongHang Nanometer Technology Development Co., Ltd., and a model thereof was ZH-ZnO20N. The isopropyl tris(dioctyl phosphoryl)titanate coupling agent was purchased from American Kenrich Company, and a designation thereof was KR-12.

The present invention further provided a preparation method of an anti-agglomeration sustained-release inorganic antibacterial material, including the following steps:
S1, 5 g of a modified phosphate was taken to be added into 300 ml of a 0.005 mol/L silver nitrate solution for stirring for 3 hours;
S2, a PH of the solution was adjusted to 11, and aging was conducted for 8 hours;
S3, a precipitate was rinsed with water until a filtrate was neutral, and the precipitate was dried; and
S4, polyethylene glycol of the same weight parts as the dried precipitation was added into the dried precipitate for even mixing, and sintering was conducted at 1100° C. to obtain powder, namely the sustained-release inorganic antibacterial material.

The polyethylene glycol had a number-average molecular weight of 5500 to 7000, and was purchased from Haian Petrochemical Plant in Jiangsu Province, and a model thereof was PEG-6000.

### Comparative Example 3

Comparative Example 3 provided an anti-agglomeration sustained-release inorganic antibacterial material, wherein a carrier of the sustained-release inorganic antibacterial material was a modified zirconium phosphate, and the sustained-release inorganic antibacterial material further contained an element Ag.

The modified zirconium phosphate was prepared by the following modification method:
30 g of zirconium phosphate powder and 3 g of nano-zinc oxide were put in 200 ml of water. Ultrasonic dispersion and stirring were conducted to obtain a uniform solution. 1 g of an isopropyl tris(dioctyl phosphoryl)titanate coupling agent was added into 30 ml of an ethanol solution to be mixed evenly, and then the above solution was added. Stirring was conducted for 1 hour in a 55° C. thermostatic water bath under 800 r/min, and then still standing for layering was conducted. Lower-layer powder was taken for drying to obtain the modified calcium phosphate.

The zirconium phosphate powder was purchased from Shanghai Runhe Nano Material Sci. & Tech. Co., Ltd., and a designation thereof was RHA-ZR. The nano-zinc oxide had an average particle size of 20 nm, and was purchased from Hefei ZhongHang Nanometer Technology Development Co., Ltd., and a model thereof was ZH-ZnO20N. The isopropyl tris(dioctyl phosphoryl)titanate coupling agent was purchased from American Kenrich Company, and a designation thereof was KR-12.

The present invention further provided a preparation method of an anti-agglomeration sustained-release inorganic antibacterial material, including the following steps:
S1, 5 g of a modified phosphate was taken to be added into 300 ml of a 0.005 mol/L silver nitrate solution for stirring for 3 hours;
S2, a PH of the solution was adjusted to 11, and aging was conducted for 8 hours; S3, a precipitate was rinsed with water until a filtrate was neutral, and the precipitate was dried; and
S4, the dried precipitate was sintered at 1100° C. to obtain powder, namely the sustained-release inorganic antibacterial material.

Performance Evaluation

Antibacterial property test: 10 ml of an MHB culture solution was added to a test tube, and inoculated with 0.1 ml of a test bacteria solution, 0.01 g of the prepared anti-agglomeration sustained-release inorganic antibacterial material was added, culturing was conducted for 24 hours at 35° C. in the dark and under a fluorescent light, respectively, and then the survival bacteria number was determined. The test bacteria solution was Escherichia coli ATCC 44113, and a bacterial concentration was 1.2×10⁶ cfu/ml. The MHB culture solution was an MH broth medium.

TABLE 1

| | Survival bacteria number | Survival bacteria |
|---|---|---|
| | under a fluorescent light | number in the dark |
| Examples | (cfu/ml) | (cfu/ml) |
| Example 1 | 3 | 90 |
| Example 2 | 3 | 90 |
| Example 3 | 4 | 100 |
| Comparative | 50 | 1100 |
| Example 1 | | |
| Comparative | 20 | 300 |
| Example 2 | | |
| Comparative | 10 | 200 |
| Example 3 | | |

It can be known from the above examples and comparative examples that the present invention provides an anti-agglomeration sustained-release inorganic antibacterial material and a preparation method thereof, and the prepared anti-agglomeration sustained-release inorganic antibacterial material has an excellent antibacterial ability and an antibacterial ability in a dark environment.

Finally, it is pointed out that the above descriptions are only preferred examples of the present invention and are not intended to limit the present invention. Any modifications, equivalent replacements and improvements made within the spirit and principles of the present invention shall be included within the scope of protection of the present invention.

What is claimed is:

1. An anti-agglomeration sustained-release inorganic antibacterial material, wherein a carrier of the sustained-release inorganic antibacterial material is a modified phosphate, and the sustained-release inorganic antibacterial material further comprises an element Ag.

2. The anti-agglomeration sustained-release inorganic antibacterial material of claim 1, wherein the modified phosphate is at least one of modified zirconium phosphate and modified calcium phosphate.

3. The anti-agglomeration sustained-release inorganic antibacterial material of claim 2, wherein the modified phosphate is prepared by the following modification method:
putting the phosphate and nano-zinc oxide in water, conducting ultrasonic dispersion and stirring until evenness, adding an ethanol solution of a titanate coupling agent for even mixing and then conducting stirring in a thermostatic water bath, conducting still standing for layering, and taking lower-layer powder for drying for obtaining the modified phosphate.

4. The anti-agglomeration sustained-release inorganic antibacterial material of claim 3, wherein an average particle size of the nano-zinc oxide is 10-30 nm.

5. The anti-agglomeration sustained-release inorganic antibacterial material of claim 4, wherein a specific surface area of the nano-zinc oxide is greater than 70 m²/g.

6. The anti-agglomeration sustained-release inorganic antibacterial material of claim 3, wherein a weight ratio of the phosphate to the nano-zinc oxide is (8-15):1.

7. The anti-agglomeration sustained-release inorganic antibacterial material of claim 3, wherein a weight ratio of the nano-zinc oxide to the titanate coupling agent is (2-4):1.

8. A preparation method of the anti-agglomeration sustained-release inorganic antibacterial material of claim 1, comprising the following steps:
S1, adding the modified phosphate into a silver nitrate solution for stirring;
S2, adjusting a PH of the solution to 10-12, and conducting aging;
S3, rinsing a precipitate with water until a filtrate is neutral, and drying the precipitate; and
S4, adding polyethylene glycol into the dried precipitate for even mixing, and conducting sintering for obtaining powder, namely the sustained-release inorganic antibacterial material.

9. The preparation method of claim 8, wherein a sintering temperature is 1000° C.-1200° C.

10. The preparation method of claim 8, wherein a number-average molecular weight of the polyethylene glycol is 5000-8000.
